(19) United States
(12) Patent Application Publication
(10) Pub. No.: US 2004/0258883 A1
(43) Pub. Date: Dec. 23, 2004

(54) Laminated roofing shingle

(75) Inventor: Casimir Paul Weaver, Northport, AL (US)

Correspondence Address: FITZPATRICK CELLA HARPER & SCINTO, 30 ROCKEFELLER PLAZA, NEW YORK, NY, 10112, US

(73) Assignee: ElkCorp.

(21) Appl. No.: 10/463,274

(22) Filed: Jun. 17, 2003

(51) Int. Cl. B32B 1/00

(52) U.S. Cl. 428/143; 427/180

(57) ABSTRACT

A laminated roofing shingle has an increased nailing zone obtained by increasing the width of the backer strip and thinning a portion of the extended backer strip underlying the nailing zone on the upper shingle layer. The thinned portion is of a width such that when a pair of the shingles are stacked one atop the other with their respective backer strips oriented in opposite directions, the respective thinned portions are aligned with one another and are separated only by the upper shingle layer of the lowermost shingle. When stacked and bundled, the extended backer strip portions do not substantially increase the height of the bundle. The height of the bundle may be further reduced by forming a longitudinally extending thinned area in the upper shingle layer overlying the thinned portion of the backer strip.

Thinning of both the backer strip portion and the upper layer is achieved by depositing on the asphalt coated mat in these areas, mineral granules of a smaller size than are deposited on the remainder of the weather surfaces of the two shingle layers or a thin self-sticking tape strip.

### TECHNICAL FIELD OF THE INVENTION

This invention relates to laminated roofing shingles and more particularly to stackable laminated shingles with expanded nailing areas.

### BACKGROUND

Laminated roofing shingles, often referred to as architectural shingles, have become increasingly popular as outer coverings for sloping roofs, providing improved weather protection and aesthetic appeal as compared to strip or three-tab shingles. The multiple layers of laminated shingles increase the durability of the roof covering and add texture and color to the roof surface as compared to strip shingles.

In a typical configuration, a laminated shingle has a first, or upper shingle layer provided with cutouts along one edge leaving a plurality of tabs, often referred to as dragon teeth. A second shingle layer or backer strip is adhesively secured to the underside of the upper layer such that it is visible in the cutouts between the tabs of the upper layer. Mineral granules of various colors are adhered on the upper surfaces of the two layers to provide weather protection and visual appeal.

A laminated shingle of the above described kind and its method of manufacture are described in U.S. Pat. No. 5,611,186, assigned to the present assignee, which is incorporated by reference in its entirety in this application. As described therein, each shingle layer is formed from an asphalt coated mat, generally fiberglass, covered with mineral granules and cut to appropriate size and shape. The overall shingle is generally rectangular in shape with the tabs extending along one longitudinal edge of the upper layer. The backer strip extends behind the tabs for the entire length of the upper layer but is narrower, extending somewhat beyond the tops of the cutouts in the upper layer.

In installing laminated shingles on a roof, the shingles are nailed to the roof deck, generally with an automatic nail gun to increase installation speed. In order to properly secure the shingles to the roof deck and prevent separation of the backer strip, the nails must be placed such that they penetrate both layers of the shingle, with the heads of the nails securing one course of shingles being covered by the shingles of the next upper course. This requires accuracy in the placement of nails in the relatively narrow nailing zone, the area between the tops of the cutouts in the upper layer and the upper edge of the backer strip. This tends to slow down the installation process, thereby increasing the overall cost of the roof.

Increasing the width of the backer strip would enlarge the nailing zone area and place less restriction on the accuracy of nail placement. However, this expedient presents a problem in shingle production. In the high speed production of laminated shingles, such as described in U.S. Pat. No. 5,611,186, it is important that the finished product be wrapped in bundles and the bundles stacked ready for shipment as efficiently as possible. Typically, because of weight and size considerations, a single bundle of shingles comprises 22 shingles, which are automatically wrapped and bundled as they come off the production line and stacked on pallets for shipment. To minimize the thickness of the bundle and enable bundles to be stably stacked on a pallet, individual shingles in the bundle are oppositely oriented, such that within each pair of successively stacked shingles, the double layer portion of the upper shingle overlies the single layer portion of the adjacent lower shingle. If the backer strip of the shingle is slightly less than one-half of the width of the upper layer, each pair will stack essentially flat, insuring that the resultant shingle bundle will be flat and stably stackable on other bundles. However, this stability has its price in that it requires that the nailing zone be limited to the relatively narrow area between the upper edge of the cutouts in the upper layer and the upper edge of the backer strip.

An attempt to expand the nailing zone and at the same time not adversely affect the stackability of the laminated shingles is described in U.S. Pat. Nos. 6,145,263 and 6,397,546 B1 to Malarkey. In the laminated shingle of these patents, the nailing zone is increased by expanding the width of the backer strip to be more than one-half of the width of the upper layer but decreasing the thickness of the expanded portion. Thus, as shown in FIG. 9 of U.S. Pat. No. 6,145,265, in each pair of shingles as they are stacked together for shipment, in the zone C, three full thickness shingle layers and one reduced thickness shingle layer are overlapped. As stated by the patentee, the tendency for the stack to bow is minimized. In the shingles of these patents, the thickness of the expanded portion of the backer strip is reduced by scraping off the asphalt coating down to the underlying mat and not applying granules to the scraped area.

In a modification of the shingle configuration shown in the above-identified Malarkey patents, the width of the backer strip is further expanded and the asphalt coating on the entire expanded width portion scraped down to the underlying mat to obtain the reduced thickness. Such a modification is incorporated in a shingle manufactured and sold by the Herbert Malarkey Roofing Co. (the assignee of the above-identified Malarkey patents) under the name “Malarkey Legacy SBS”.

### SUMMARY OF THE INVENTION

In accordance with the present invention, the area of the nailing zone of a laminated shingle is substantially increased by providing a reduced thickness expanded portion of the backer strip, without significantly impacting the stacking and bundling of finished shingles as in prior art shingles. However, rather than reducing the thickness of the backer strip by scraping off asphalt previously applied to the underlying fiberglass mat, the present invention achieves the reduction in thickness simply by covering the applied asphalt on the expanded width portion with a non-stick coating substantially thinner than the layer of mineral granules applied to the remainder of the mat surface.

In a second preferred embodiment, the upper shingle layer of the shingle has a thinned lengthwise extending portion substantially coextensive with and overlying the thinner portion of its associated backer strip.

In both embodiments, the reduction in thickness of a shingle layer is obtained by applying to the asphalt coated mat underlying the thinned portions mineral granules which are substantially finer than the mineral granules applied to the remaining weather surfaces of the upper layer and backer strip. Alternatively, the coating on a thinned portion may be a strip of self-sticking tape of the type commonly used elsewhere on shingles to prevent shingles from sticking to one another when packaged. This production step does not require removal of material from an already coated mat and is uniquely applicable to a “4 wide” manufacturing arrangement, as will be discussed below.

### BRIEF DESCRIPTION OF THE DRAWINGS

The foregoing and other features and advantages of the invention will become apparent from the following detailed description thereof, taken in conjunction with the appended drawings, in which:

FIG. 1 is a broken perspective view of a prior art laminated shingle indicating the conventional nailing zone;

FIG. 2 is a broken perspective view of a prior art laminated shingle with an expanded area nailing zone.

FIG. 3 is a broken perspective view of a laminated shingle illustrating a further expanded area nailing zone of a shingle;

FIG. 4A is a partial cross-section of a backer strip illustrating one embodiment of the invention for obtaining the thinned portion of the backer strip;

FIG. 4B is a partial cross-section of a backer strip illustrating an alternative embodiment of the invention for obtaining the thinned portion of the backer strip;

FIG. 5 is a broken perspective view of a laminated shingle showing the expanded area nailing zone of a second embodiment of the present invention.

FIG. 6 is an end view of a pair of the prior art shingles of FIG. 1 stacked one above the other;

FIG. 7 is an end view of a pair of the prior art shingles of FIG. 2 stacked one above the other;

FIG. 8 is an end view of a pair of the shingles of the shingles of FIG. 3 stacked one above the other;

FIG. 9 is an end view of a pair of shingles of the invention shown in FIG. 5 stacked one above the other; and

FIG. 10 is a sheet layout illustrating the application of the invention to a 4-wide manufacturing system.

### DETAILED DESCRIPTION OF THE INVENTION

A brief overview of prior art laminated shingles will be helpful in understanding the present invention.

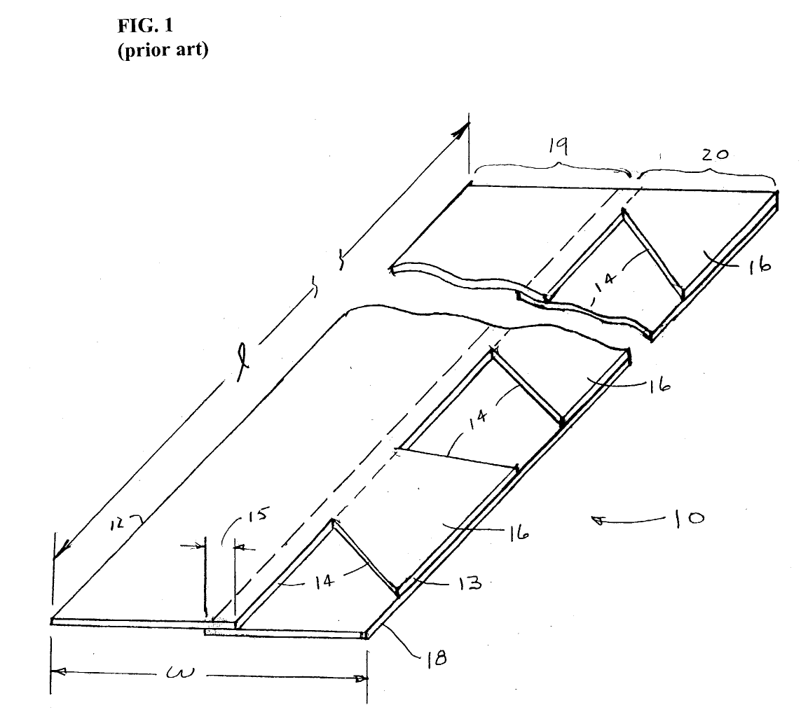

In FIG. 1, a laminated roofing shingle of the type such as disclosed in U.S. Pat. No. 5,611,186 is illustrated. The shingle 10 comprises an upper shingle layer 12 of generally rectangular shape having a length l and a width w. Typically, the length l will be about 36 inches and the width w about 12 inches. (Larger sized metric shingles have a length of 1 meter (39⅜ inches) and a width of 337 mm (13¼ inches)). The right-hand edge 13 of the layer 12 (which will be the lowermost or bottom edge of the shingle when installed on a roof) includes a series of cutouts 14 leaving a plurality of tabs 16.

Laminated to the underside of layer 12 by a suitable adhesive is a second shingle layer or backer strip 18 which has a length equal to l and a width usually just slightly less than one-half w. As will be understood, the upper surface of backer strip 18 will be visible between the tabs 16 of shingle layer 12 and the lower edge of the backer strip will be aligned with the lower edges of the tabs 16 in upper layer 12 along a straight line.

Typically, each of the shingle layers 12 and 18 is formed from a fiberglass mat coated on both sides with asphalt, although the mat may also be of an organic felt or other material. The upper or weather surface of the asphalt coated mat is covered with various types of mineral granules which may be ceramic coated, to protect the asphalt coating, to add color to the shingle and to provide fire resistance. The undersides of the two layers are coated with ultra fine mineral granules or dust, substantially finer than the granules on the weather surfaces. A plurality of self-sealing adhesive strips (not shown) may be disposed on the upper surface of shingle layer 12, in the region where the headlap section 19 meets the buttlap section 20.

In installing successive courses of laminated shingles, each shingle of an upper course is aligned such that it overlays the upper portion, or headlap 19, of the shingles of the preceding lower course and part of the lower portion, or buttlap 20, the bottom edge of the upper shingle being aligned with the tops of the cutouts 14. Each shingle is secured to the underlying roof deck by nails driven through both shingle layers. To insure that both shingle layers are firmly fastened to the deck and that the nail heads are covered by the succeeding course of shingles, the nails must be driven in the region 15 between the tops of the cutouts and the upper end of the backer strip, referred to as the nailing zone, indicated between the dashed line and the tops of the cutouts 14 in FIG. 1, which extends the full length of the shingle. In a typical laminated shingle, the width of the nailing zone is slightly less or more than 1 inch. With the nailing target so narrow, shingle manufacturers often imprint a line on the upper surface of each shingle to indicate the desired location for the nails.

Economically efficient roofing installation requires that shingles be laid down and nailed rapidly to the roof deck. Whether done by hand or with a power driven nail gun, ensuring that the nails are consistently driven through the nail zone of each shingle presents a formidable challenge, especially with high speed nail guns.

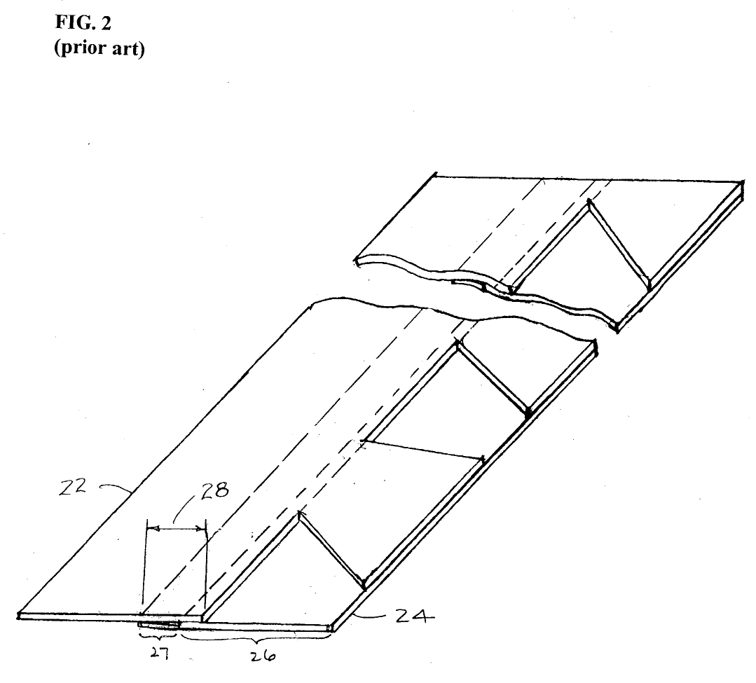

To address this problem, a laminated shingle with an extended backer strip has been devised. Such a shingle, illustrated in FIG. 2 and described in above-noted U.S. Pat. Nos. 6,145,265 and 6,397,546 B1, has a tabbed upper layer 22, similar to layer 12 of FIG. 1, and a backer strip 24, divided lengthwise into a first portion 26 of a thickness the same as upper layer 22 and a second portion 27, substantially thinner than portion 26. As described in the noted patents, the thinner portion is obtained by mechanically scraping the asphalt off the edge of the expanded backer strip down to the underlying mat during the manufacturing process and not applying granules to the scraped area. In this case, the backer strip 24 is wider than the backer strip 18 of FIG. 1, thereby providing a wider nailing zone 28.

While this expedient advantageously increases the width of the nailing zone to reduce nailing errors, it creates a problem in the bundling and stacking of shingles for shipment. Asphalt shingles are inherently heavy, and to permit shingles to be handled and lifted to and distributed over a roof deck prior to installation, shingles typically are automatically bundled in stacks of 22 with the weather surface of each shingle facing the under surface of the shingle above it and the backer strips of successive shingles oriented in opposite directions.

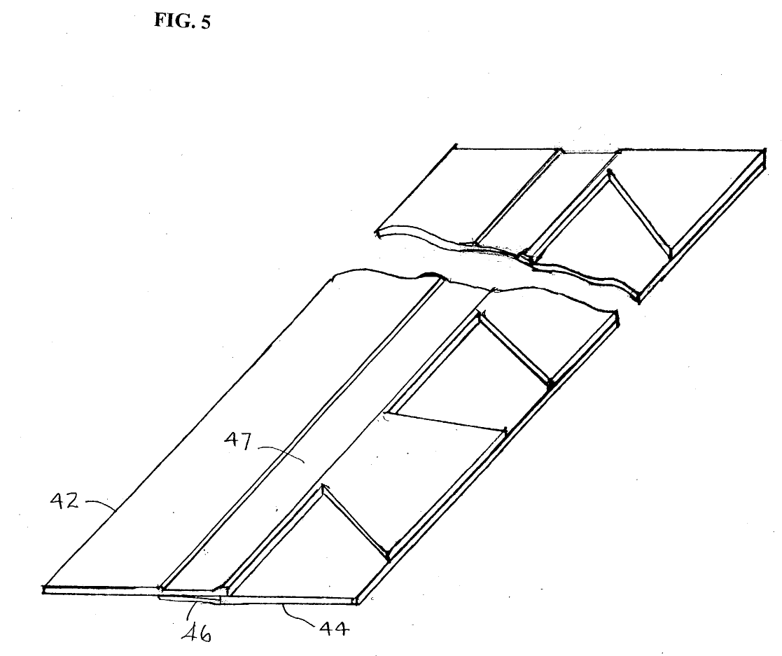

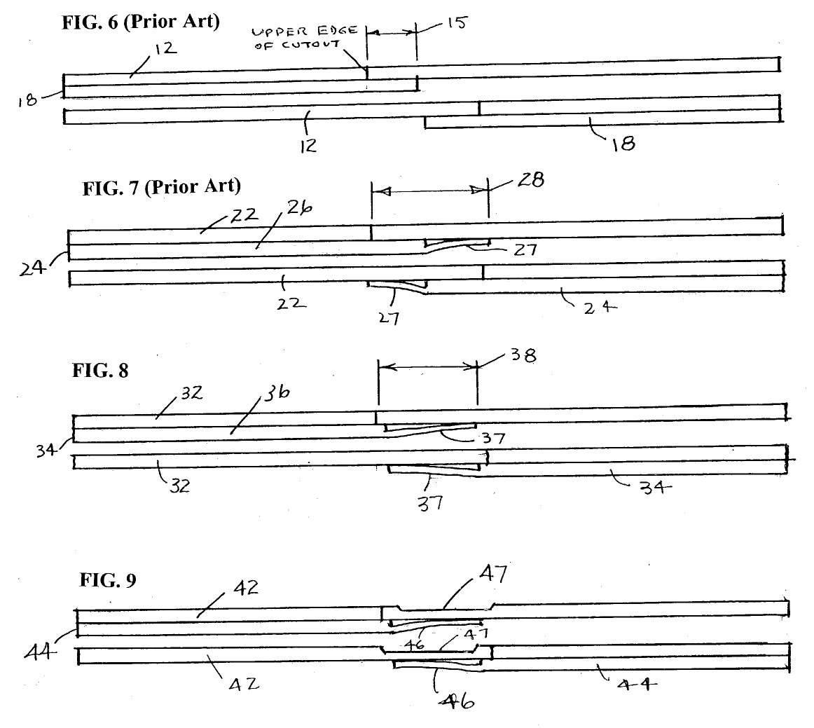

This bundling arrangement is illustrated in FIG. 6, which is an end view of a pair of the shingles of FIG. 1 (with thicknesses exaggerated for clarity) stacked as they would be in a bundle of 22 shingles, it being understood that there would be 11 such pairs in the complete bundle. The nailing zone is indicated at 15. It is seen that since the oppositely oriented backer strips 18 do not overlap, the greatest thickness of the pair of stacked shingles is three times the thickness of an individual shingle layer and the completed, wrapped bundle will have little or no crown along its center.

A pair of similarly stacked shingles of the type illustrated in FIG. 2 is shown in FIG. 7, with the expanded nailing zone indicated at 28. As shown, when stacked, the thinner expanded portion 27 of each shingle overlaps both the full thickness of the backer strip 24 and the upper layer 22 of the shingle above it, thereby adding the thickness of 11 of the portions 27 to a stack of 22 shingles, as compared to a bundle of the shingles of FIG. 1. Considering typical shingle sheet thicknesses, this could result in a crown of as much as 0.440 inches along the central area of a 22 shingle bundle, presenting a palleting and storage problem.

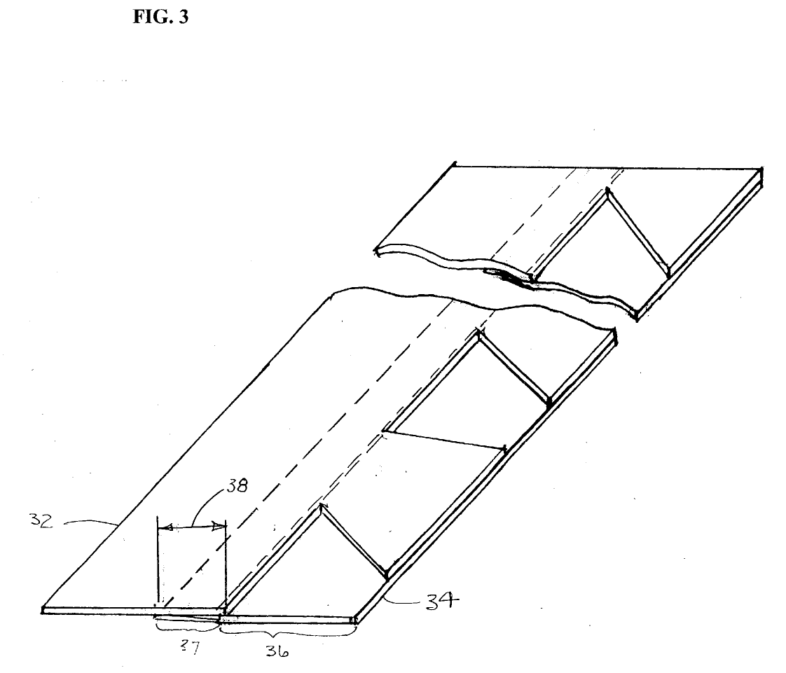

The foregoing stacking problem is mitigated by the shingle construction of FIG. 3, which, while further expanding the size of the nailing zone, decreases the crown in a shingle bundle as compared to the shingle construction of FIG. 2. As shown, the backer strip 34 has a first lengthwise extending portion 36 of a thickness equal to the thickness of the upper layer 32 and a second lengthwise extending portion 37 of a thickness substantially less than that of portion 36. As shown, the thinned portion begins closer to the exposed portion of the backer strip, i.e., the upper edge of the cutouts in the upper layer, than in the prior art shingles of FIGS. 1 and 2. In accordance with the invention, the thinning of the portion 37 is achieved simply by applying only ultrafine mineral granules or fines to the upper surface of the mat underlying portion 37, instead of the relatively course granules applied to the upper surface of the mat on the remainder 36 of the backer strip. This may be readily accomplished during production of the shingles by depositing the fines on the mat with the granule application techniques described in the above-mentioned U.S. Pat. No. 5,611,186. Alternatively, a layer of thin, self sticking tape, such as the release tape commonly used on shingles to prevent sticking in packaging, may be applied over the mat in the thinned areas, in place of the ultrafine mineral granules.

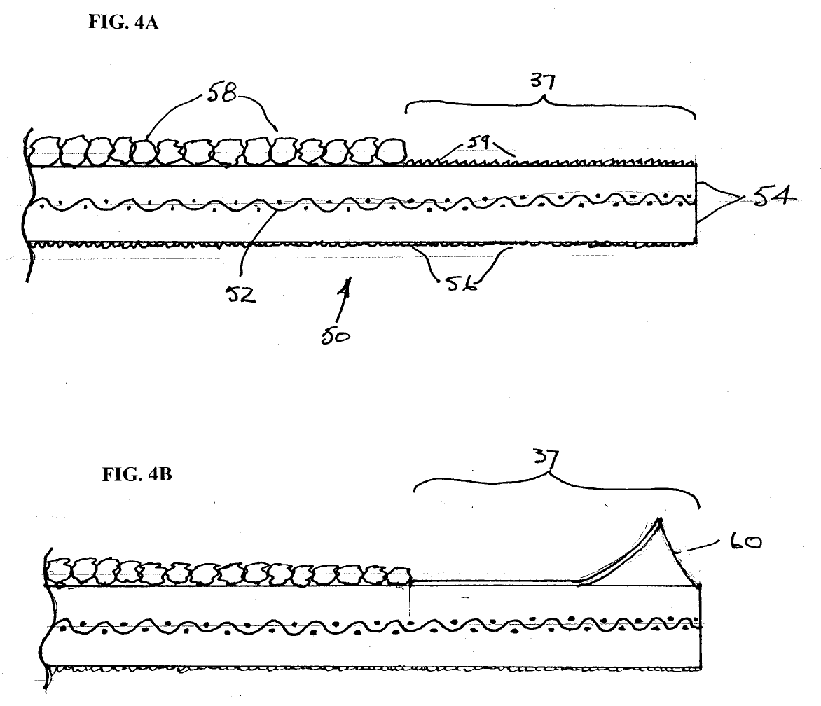

The two embodiments described above are illustrated in FIGS. 4A and 4B respectively, which are partial cross sections (not to scale) of the backer strip, showing the thinned portion 37 of FIG. 3. In the figures, the underlying mat 50 comprises a fiberglass matrix 52 coated on both sides with asphalt 54. The underside of the mat 50 is sealed with fines 56. The upper side of the mat is coated over most of its surface with relative coarse mineral granules 58 forming the weather surface of the backer strip. To provide the thinned portion 37, the asphalt is coated with substantially smaller granules or fines 59 to seal the surface. The fines 59 may be the same as the fines 56 sealing the underside of the mat.

In the embodiment of FIG. 4B, a thin strip of self-sticking tape 60 is adhered to the surface of the asphalt in the region 37 in place of the fines 56 of FIG. 4A. As can be seen from both FIGS. 4A and 4B, the thickness of the backer strip in the region 37 is significantly reduced without the necessity of removing the asphalt coating on the underlying mat.

Referring now to FIG. 8, which shows a pair of the shingles of FIG. 3 as they would be stacked in a full shingle bundle, the width of the thinned portion 37 is such that when two such shingles are stacked, as shown in FIG. 7, the longitudinal edges of the respective portions 37 are aligned one above the other and separated only by the shingle layer 32 of the lower shingle of the pair. Thus, the overall thickness of a shingle pair in the overlap region is made up of two full thicknesses of shingle layer 32 and two thicknesses of reduced thickness portion 37. In a typical shingle produced in accordance with the present invention as shown in FIGS. 4A and 4B, the thickness of the portion 37 would be 0.060 inch and the thickness of the layer 32 would be 0.095 inches. In a 22 shingle bundle, this would result in a crown of 0.275 inches, significantly less than the 0.440 inches of the prior art shingle of FIG. 3.

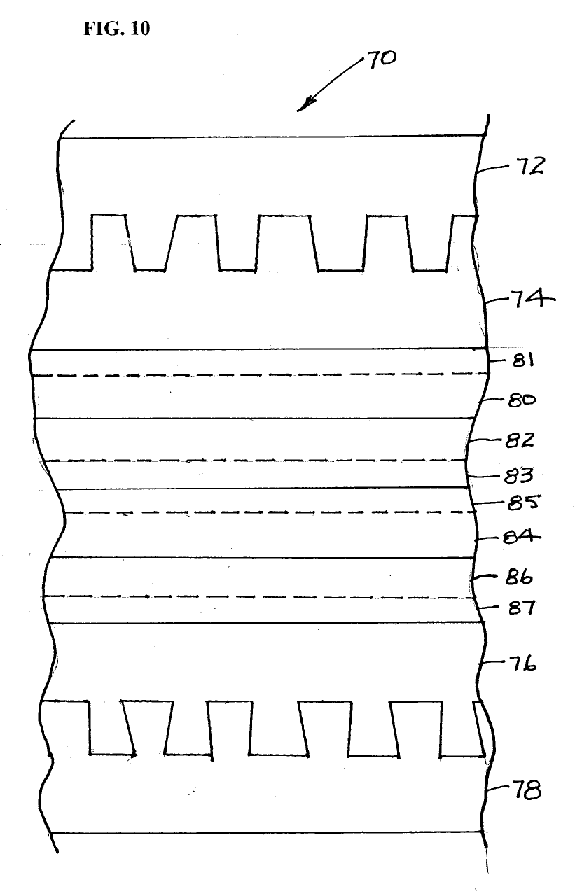

A further reduction of the bundle crown while maintaining the wider nailing zone of FIG. 3, is obtained with the modification illustrated in FIGS. 5 and 9. As shown therein, a thinned-out lengthwise extending depressed portion 47 is created in the upper surface of shingle layer 42, overlying and substantially coextensive with the thinned portion 46, simply by applying finer granules to the surface of the underlying mat along the depressed portion than are applied to the remainder of the shingle surface. This can be readily accomplished, for example, by employing the granule application techniques described in U.S. Pat. No. 5,611,186. Alternatively, tape may be applied to the mat in the area 47, similar to FIG. 4B. The depressed area 42 will be covered by the succeeding shingle course on installation. The reduction in thickness obtained in this area can be from 0.010 to 0.015 inches per shingle, further reducing the bundle crown while maintaining the increased area nailing zone.

The application of fine granules or tape to the underlying mat to create the thinned-out portion of the backer strip provides an important advantage not obtainable with the scraping techniques of the prior art. In FIG. 7 of the above-identified Malarkey patents, a mat layout for a so-called “2 wide” shingle manufacturing process is illustrated. The designation “2 wide” indicates that, as shown in the patent drawing, the mat is cut into two separate pairs of shingle components, i.e., top layer 104 with backer strip 96 and top layer 106 with backer strip 106. As described in the Malarkey patent specification, the thinned-out portions 82 of the backer strips are obtained by scraping the asphalt away from the underlying mat along the respective outer edges of the mat. Presumably, the asphalt removed from the mat is returned to the asphalt bath from which the mat has just emerged, leaving no unwanted residue on the remainder of the mat surface.

While this technique is satisfactory in a “2 wide” system, it is incompatible with the “4 wide” system, to which the shingle industry is rapidly converting. As illustrated in the mat layout of FIG. 10, in a “4 wide” system, the mat 70 will ultimately be cut, after application of granules to the asphalt coated surfaces, to provide 4 pairs of shingle components: upper tabbed shingle layers 72, 74, 76, 78, and backer strips 80, 82, 84, 88. Each of the backer strip segments 80, 82, 84 and 86 has a reduced thickness portion along one edge, 81, 83, 85 and 87, respectively, obtained by depositing fine granules or tape to the mat surface in those areas. This can be readily achieved by use of the granule depositing equipment and techniques described in the above-mentioned Weaver U.S. Pat. No. 5,611,186. In the same way, fine granules or tape may be deposited along strips of the upper shingle layers 72, 74, 76 and 78 to produce the reduced thickness regions 47 of FIG. 5.

As will be seen from FIG. 10, all of the reduced thickness strips 81, 83, 85, 87 are separated from the outer edges of the mat 70. Consequently, scraping techniques such as used in the prior art Malarkey shingles cannot be employed, since scraping would leave unacceptable clumps of asphalt debris on the mat and interfere with uniform deposition of granules on the surface. Although the location of the backer strips on the mat may be varied from that shown in FIG. 10, at most only 2 of the backer strips could be along the edges of the mat, where they must be to permit scraping. The other two of the backer strips would be on the interior of the mat, away from the edges, and would not allow scraping. Obviously, scraping would not be permissible to provide reduced thickness portions in the upper layers 72, 74, 76 and 78. It will be appreciated then that the deposition of fine granules to create the thinned portions of the shingle layers, and the expanded nailing zone, is applicable to a “4 wide” shingle manufacturing system, while the prior art scraping technique is not.

It will be understood that in place of granule hoppers, such as shown in Weaver U.S. Pat. No. 5,611,186, for depositing the fine granules for the thinned-out portions of the shingle layers, rolls of self-sticking tape may be substituted to obtain the thinner regions, as indicated in FIG. 4B.

Various modifications, variations and substitutions may be made in the present invention as described without departing from the spirit and scope of the invention as defined by the appended claims. For example, the principles of the invention are equally applicable to laminated shingles of other constructions, such as that shown in U.S. Design Pat. No. Des. 369,421.

I claim:

1. A laminated roofing shingle comprising:
a first shingle layer having a length l and a width w;
a second shingle layer laminated to the underside of said first layer and having a length equal to length l and a width greater than ½ w;
each of said shingle layers comprising an asphalt-covered mat and a surface coating over the asphalt on the upper side of said mat;
said second shingle layer having a first lengthwise extending portion of a thickness substantially equal to the thickness of said first shingle layer and a second lengthwise extending portion of a thickness substantially less than the thickness of said first lengthwise extending position;
the difference in thickness between said first and second lengthwise extending portions equal to a difference in thickness between the surface coatings on said respective portions;
said second lengthwise extending portion having a width such that when a pair of said shingles are stacked one atop the other with their respective second layers oriented in opposite directions, said respective second lengthwise extending portions are aligned with each other, and said second lengthwise extending portions are separated only by the first shingle layer of the lowermost shingle.

2. The laminated roofing shingle of claim 1 above wherein:
said surface coating on said first shingle layer and said first lengthwise extending portion of said second shingle layer comprises mineral granules of a given coarseness; and
said surface coating on said second lengthwise extending portion comprises mineral granules substantially finer than said given coarseness.

3. The laminated roofing shingle of claim 1 wherein:
said surface coating on said first shingle layer and said first lengthwise extending portion of said second shingle layer comprises mineral granules of a given coarseness; and
said surface coating on said second lengthwise extending portion of said second shingle layer comprises tape thinner than the thickness of the surface coating provided by the mineral granules of said given coarseness.

4. The laminated roofing shingle of claim 1 wherein
said first shingle layer includes a lengthwise extending portion having a thickness substantially equal to the thickness of said second lengthwise extending portion of said second shingle layer and overlying said second lengthwise extending portion.

5. The laminated roofing shingle of claim 4 wherein said lengthwise extending portion of said first shingle layer and said second lengthwise extending portion of said second shingle layer are substantially coextensive.

6. The laminated roofing shingle of claim 4 wherein:
said surface coating on said first shingle layer except for said lengthwise extending portion thereof and the surface coating on said first lengthwise extending portion of said second shingle layer comprise mineral granules of a given coarseness; and
said surface coatings on said lengthwise extending portion of said first shingle layer and said second lengthwise extending portion of said second shingle layer comprise mineral granules substantially finer than said given coarseness.

7. The laminated roofing shingle of claim 4 wherein:
the surface coating on said first shingle layer except for said lengthwise extending portion thereof and the surface coating on said first lengthwise extending portion of said second shingle layer comprise mineral granules of a given coarseness; and
the surface coating on one of said lengthwise extending portion of said first shingle layer and said second lengthwise extending portion of said second shingle layer comprises mineral granules substantially finer than said given coarseness and the surface coating on the other of said lengthwise extending portions comprises tape thinner than the thickness of the surface coating provided by the mineral granules of said given coarseness.

8. The laminated roofing shingle of claim 4 wherein:
said surface coating on said first shingle layer except for said lengthwise extending portion thereof and the surface coating on said first lengthwise extending portion of said second shingle layer comprises mineral granules of a given coarseness; and
the surface coating on both said lengthwise extending portion of said first shingle layer and said second lengthwise extending portion of said second shingle layer comprises tape thinner than the thickness of the surface coating provided by the mineral granules of said given coarseness.

9. The laminated roofing shingle of claims 1 or 4 wherein said upper shingle layer has a plurality of tabs formed along one longitudinal edge thereof with openings between said tabs and the length of the tabs from said longitudinal edge having less than ½ w.

10. The laminated roofing shingle of claim 9 wherein one longitudinal edge of said second shingle layer is aligned with said one longitudinal edge of said upper shingle layer.

11. In a method of manufacturing a laminated roofing shingle having an upper shingle layer and a bottom shingle layer having its upper surface adhesively secured to the under surface of the upper shingle layer, each of said shingle layers comprising an asphalt-covered mat, the steps of:
applying to a first lengthwise extending portion of the upper surface of said bottom shingle layer a coating of mineral granules of a given coarseness; and
applying to a second lengthwise extending portion of the upper surface of said bottom shingle layer adjacent to said first lengthwise extending portion a coating substantially thinner than the thickness of the coating provided by the mineral granules of said given coarseness.

12. The method of claim 11 further comprising the step of:
applying to all of the upper surface of said upper shingle layer a coating of mineral granules of said given coarseness.

13. The method of claim 11 wherein the coating applied to said second lengthwise extending portion of the upper surface of said bottom shingle layer comprises mineral granules of substantially finer coarseness than said given coarseness.

14. The method of claim 11 wherein the coating applied to said second lengthwise extending portion of the upper surface of said bottom shingle layer comprises tape thinner than the thickness provided by the mineral granules of said given coarseness.

15. The method of claim 11 further comprising the steps of:
applying to all but a lengthwise extending portion of the upper surface of said upper shingle layer a coating of mineral granules of said given coarseness, the width of said lengthwise extending portion of said upper surface of said upper shingle layer being substantially less than the entire width of said upper shingle layer; and
applying to said lengthwise extending portion of said upper surface of said upper shingle layer a coating substantially thinner than the thickness of the coating provided by the mineral granules of said given coarseness;
said lengthwise extending portion of the upper surface of said upper shingle layer overlying said second lengthwise extending portion of the upper surface of said bottom shingle layer.

16. The method of claim 15 wherein the coatings applied to said first lengthwise extending portion of the upper surface of said bottom shingle layer and said lengthwise extending portion of the upper surface of said upper shingle layer comprise mineral granules of a substantially finer coarseness than said given coarseness.

17. The method of claim 15 wherein the coating applied to one of said first lengthwise extending portion of the upper surface of said bottom shingle layer and said lengthwise extending portion of said upper shingle layer is tape and the coating applied to the other of said lengthwise extending portions comprises mineral granules of a substantially finer coarseness than said given coarseness.

18. The method of claim 14 wherein the coatings applied to both of said lengthwise extending portions comprise tape.
